(19) United States
(12) Patent Application Publication
(10) Pub. No.: US 2015/0199704 A1
(43) Pub. Date: Jul. 16, 2015

(54) ADMINISTERING AN eREWARDS PROGRAM USING DYNAMIC GEO-FENCING

(71) Applicant: fisoc, Inc., Austin, TX (US)

(72) Inventors: Wesley Gottesman, Austin, TX (US); Bruno Loviat, Austin, TX (US); Daniel Edward Kim, Austin, TX (US); Jay P. Valanju, Austin, TX (US); David H. Fruhling, II, Austin, TX (US); Brian Rainey, Austin, TX (US)

(21) Appl. No.: 14/596,995

(22) Filed: Jan. 14, 2015

Related U.S. Application Data
(60) Provisional application No. 61/927,336, filed on Jan. 14, 2014.

(51) Int. Cl. G06Q 30/02

(52) U.S. Cl. CPC G06Q 30/0226

(57) ABSTRACT

Utilizing geo-fencing technology on mobile devices, notifications are sent to a user when they enter a variable sized radius of a merchant offering an eReward. The notification may allow the user to redeem the reward directly from the notification, by allowing the user to confirm their intent and causing the user to receive a terms and conditions alert. Once the terms and conditions alert is accepted, the user will hit a website end-point that will deduct the points from the eRewards account and present the eReward to the mobile client device, e.g., into a “passbook” or the like. In a preferred embodiment, only users with the capability to purchase the reward will be notified, and users will be able to one-step redeem the award from the notification itself.

### CROSS-REFERENCES TO RELATED APPLICATIONS

This application claims the benefit of U.S. Provisional Patent Application Ser. No. 61/927,336, filed Jan. 14, 2014, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The invention relates generally to administering an eRewards program and, more particularly, to using dynamic geo-fencing around a corresponding merchant and notifying users that enter the geo-fence with push notifications to redeem a reward.

Many rewards programs are profitable only with breakage, which is where points earned by user members are not redeemed, however resulting in low customer satisfaction. Users have the desire to redeem points to get rewards but may be unaware when they are in an area where redemptions are available. The users currently have to browse the web for a merchant that offers rewards, find a merchant in the area where they are going, buy the reward, print out the reward paperwork, drive to the store, and present the information. This process is time-consuming for the consumer and limits customer interaction for the merchant.

### BRIEF SUMMARY OF THE INVENTION

The system and methodology according to preferred embodiments increase customer satisfaction by promoting a higher percentage redemption. The preferred embodiments describe a system and method where a user is proactively encouraged to redeem their points. Utilizing geo-fencing technology on mobile devices, notifications are sent to the user when they enter a variable sized radius of a merchant offering an eReward. The notification may allow the user to redeem the reward directly from the notification, by allowing the user to confirm their intent and causing the user to receive a terms and conditions alert. Once the terms and conditions alert is accepted, the user will hit a website end-point that will deduct the points from the eRewards account and present the eReward to the mobile client device, e.g., into a “passbook” or the like. In a preferred embodiment, only users with the capability to purchase the reward will be notified, and users will be able to one-step redeem the award from the notification itself. The system and methodology enable single-click purchasing through geo-marketing.

In an exemplary embodiment, a method of administering an eRewards program using dynamic geo-fencing includes the steps of (a) enabling a member merchant to offer an eReward in exchange for points in the eRewards program; (b) a server computer defining a geo-fence around a place of business of the member merchant; (c) when a client mobile device of a member user is detected within the geo-fence, the server computer determining whether the member user has sufficient points to redeem the eReward; and (d) when the member user has sufficient points to redeem the eReward, the server computer sending a notification to the client mobile device.

The notification sent in step (d) may include an identification of the eReward and a point cost to redeem the eReward, wherein the method may further include sending a purchase link to the client mobile device for the member user to purchase the eReward. When the member user decides to purchase the eReward, the method may further include the steps of: the server sending a confirmation link to the client mobile device including terms and conditions; the server enabling the member user to accept the terms and conditions by selecting the confirmation link; and when the member user accepts the terms and conditions, the server deducting the points from the member user account in the eRewards program and presenting the eReward to the client mobile device for redemption at the member merchant place of business.

Step (b) may be practiced by varying a size of the geo-fence according to at least one of member user characteristics and member merchant preferences. Step (b) may be practiced such that the geo-fence may be defined differently for different member users according to the member user characteristics. In one embodiment, the member user characteristics include member shopping history. The member user characteristics may include member location and direction and speed of travel. The member merchant preferences may be determined according to maximum location awareness.

Step (b) may be practiced by varying a size of the geo-fence according to the eReward.

In another exemplary embodiment, a computer system administers an eRewards program using dynamic geo-fencing. The computer system includes at least one client mobile device of a member user, the client mobile device including a memory, a processor and a display. A system server running a server program and the at least one client mobile device are interconnected by a computer network. The system server includes a geo-fence construction resource that establishes a geo-fence around a place of business of a member merchant offering an e-Reward in exchange for points in the eRewards program. The system server is programmed to detect when the at least one client mobile device is physically present within the geo-fence, and when the system server determines that the member user has sufficient points to redeem the eReward, the system server is programmed to send a notification to the client mobile device.

In yet another exemplary embodiment, a method includes the steps of (a) enabling a member merchant to offer an eReward in exchange for points in the eRewards program; (b) a server computer defining a geo-fence around a place of business of the member merchant; and (c) when a client mobile device of a member user is detected within the geo-fence, the server computer sending a notification to the client mobile device. A size of the geo-fence is selectively variable based on at least one of member merchant preferences, member user characteristics, and the eReward.

### BRIEF DESCRIPTION OF THE DRAWINGS

These and other aspects and advantages of the invention will be described in detail with reference to the accompanying drawings, in which:

FIG. 1 is a block diagram showing an overall system linked to a network of mobile devices;

FIG. 2 shows an exemplary geo-fence around a place of business of a member merchant; and

FIG. 3 is an exemplary screen image for a notification sent to a client mobile device when the client mobile device is detected within the geo-fence.

### DETAILED DESCRIPTION OF THE INVENTION

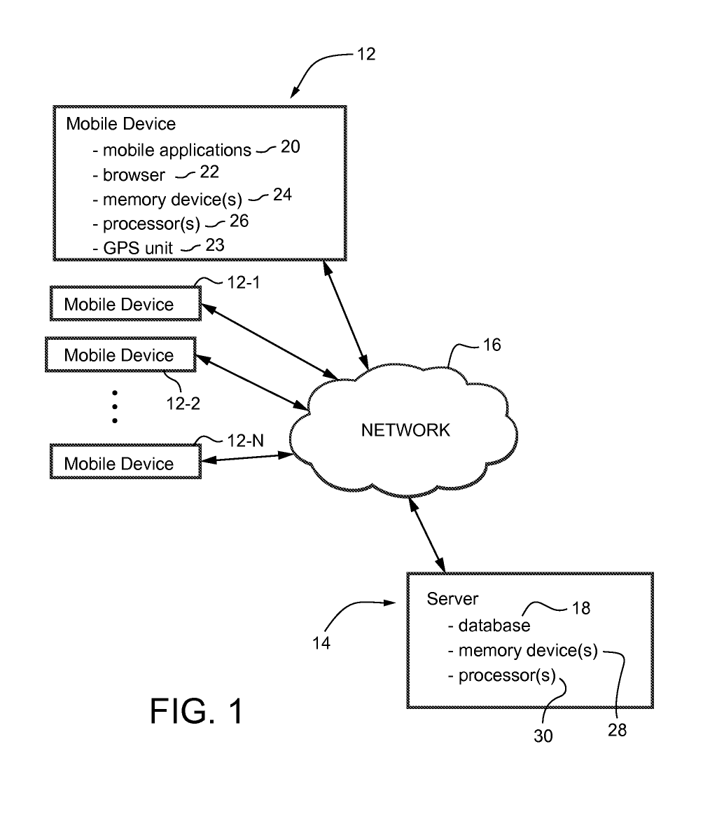

FIG. 1 shows a block diagram illustrating an overall system 10 in which a mobile device 12 transmits a request to, and receives content from, a server 14 via a network 16. Network 16 may be the Internet, a cellular network, a wired network, a wireless network, a cloud computing network, or other conventional network technology as generally recognized in the art. It is to be understood that, in practice, there will be plural and likely a very large number of mobile devices (12-1, 12-2 . . . 12-N) connected to the network 16. Also, the server 14 may be a unitary device but would preferably be implemented as a server farm or a distributed computing system in order to handle large capacities of content stored in a database 18 and the many simultaneous connections with mobile devices 12.

The mobile devices 12 may include conventional components such as one or more mobile applications 20, a browser 22, a GPS unit 23, one or more memory devices 24, and one or more processors (CPUs) 26. Conventional components such as displays, speakers, microphones, connectors, and input devices may also be included in the mobile device 12 as is well known. Examples of mobile devices 12 include such known devices as smart phones, tablets, etc., but it is to be understood that the device 12 need not be a mobile device and that the inventive concepts apply to other computing devices such as a desktop PC.

The server 14 may similarly include conventional components such as one or more memory devices 28 and one or more processors (CPUs) 30.

The execution of a typical software program illustrates that software implemented processes perform rapid activation and deactivation of transistors. Software defined instructions operate on the information stored within transistor elements. A software program may perform hundreds of millions of such operations per second. In essence, software instructions temporarily reconfigure electronic pathways and transform computing hardware to perform real, useful, and physical activity.

When an algorithm is implemented in software, it necessarily controls the hardware components to carry out computerized actions. The software thus transforms a computer into different machines and provides very different experiences.

Structure for execution of mobile software technology is described in many U.S. patents and published U.S. patent applications, for example, U.S. Pat. No. 8,694,520 and U.S. Publication No. 2014/0324692, the contents of which are hereby incorporated by reference.

According to preferred embodiments, utilizing geo-fencing technology on mobile devices, notifications are sent to a member user when the user enters a variable radius of a member merchant offering an eReward. In preferred embodiments, the notification will allow the member user to redeem the eReward directly from the notification, enabling the user to confirm the user's intent to redeem and causing the user to receive a terms and conditions alert. Once the terms and conditions alert is accepted, the member user will hit a website end-point that will deduct the points from their eRewards account and present the eReward to the client mobile device for redemption at the member merchant place of business. The system thus enables single-click purchasing through geo-marketing.

Geo-fencing technology is known and typically uses global positioning system (GPS) or radio frequency identification (RFID) to define geographical boundaries. A geo-fence is essentially a virtual barrier. In one embodiment, the geo-fences according to preferred embodiments of the invention are variable based on both user and merchant preferences. The geo-fence may similarly be variable based on the eReward product. For example, a member user may show a propensity to shop outside of a geo-area due to a shopping history and/or an indication that the user's current location is rapidly changing (e.g., driving in a car versus walking). By this and other characteristics, the system would assume that the user is willing to go a farther distance to redeem an award. The previous shopping behaviors will also be considered to determine if the user visits certain categories of merchants at a greater distance variance than other categories of merchants (e.g., a user may travel farther for a hardware store than for a restaurant).

These indicators/characteristics help the system draw individual geo-fences for users. The geo-fences may similarly be varied based on member merchant preferences as the member merchants are most familiar with their customers. For example, based on having a limited set of purchased triggers, the merchant can instruct the system to only pull at “maximum location awareness” or down to a more broad approach. “Maximum location awareness” refers to customers that (a) have shown a propensity for spending in a contained area or are traveling in a relevant direction and speed, and (b) are currently within a very tight geo-radius of the merchant. Member merchants may also access self-identified customer interests through member surveying. Since the member merchant is paying for each triggered notification, there is an incentive to instruct the system when to send out the notification based on their own knowledge of their customers.

This two-way individualized geo-fence technology allows maximum returns for both users and merchants as accuracy of relevance is significantly boosted.

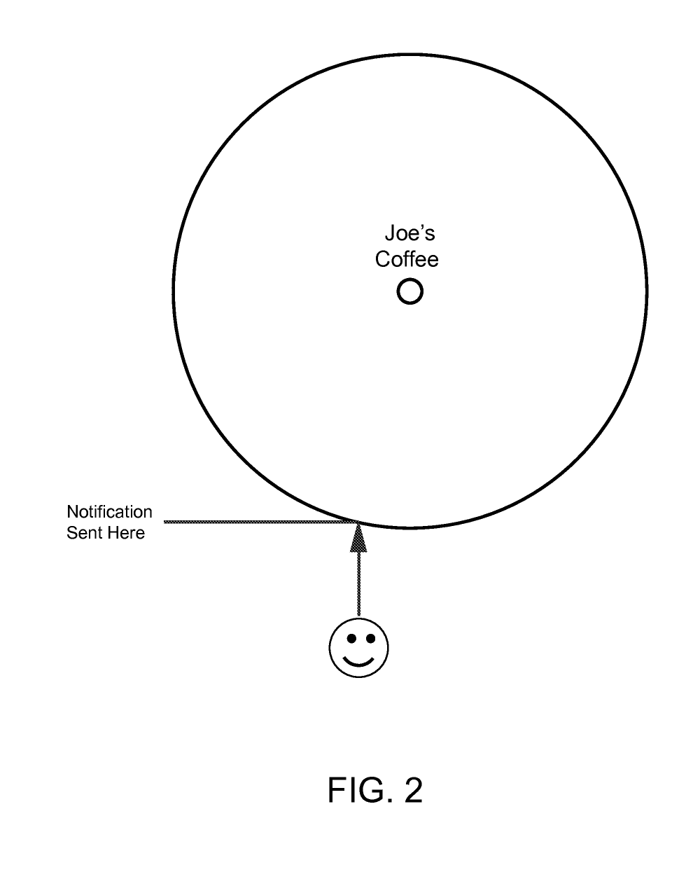

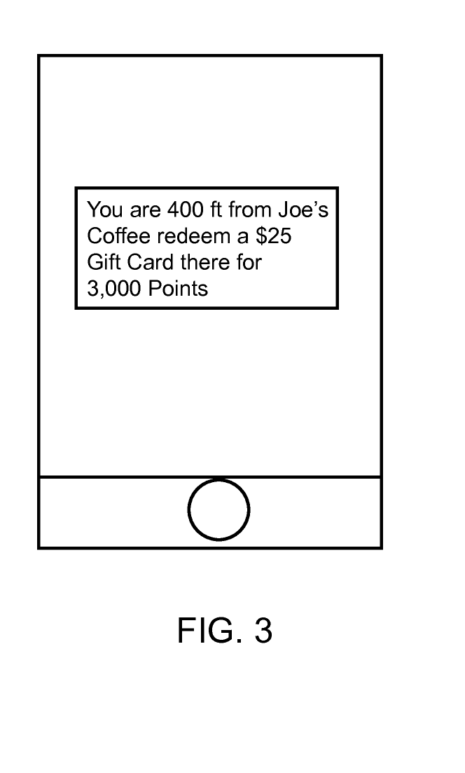

By way of an example, a member user may be walking to his or her office, and the member user enters a system-generated geo-fence (see FIG. 2). The member user receives a notification that a merchant nearby (i.e., within the geo-fence) is offering an eReward due to the user's proximity to the location and also possibly due to the user's propensity to spend within the area (see FIG. 3). If the member user is interested in redeeming the eReward (i.e., a discount or free merchandise from that merchant), the user agrees to purchase the reward. Immediately after accepting the reward from the notification, the user is prompted to accept the terms and conditions, and the user is sent to a landing page that congratulates the user on the purchase and allows the user to open the redemption. The redemption can then be validated upon entry into the store.

The merchants will be able to turn on geo-fencing when they create an eReward. Once this setting is turned on, their business location is used as a home point for geo-fencing. Through a process of digitally drawing multiple circles around the merchant, a digital geo-fence is created that can be specified by both the interacting user's previous behaviors and the merchant's choice for targeting. The different circles signify different approach points where notifications can be triggered as users cross the plane (see FIG. 2). The merchant, by choosing a setting within their dashboard, decides how to allocate their notifications by setting the distance setting for the notification lines. Users with a broader spending area will be notified as they cross a further boundary than a more narrow spending area, however, the merchant instructs just how broad those areas exist by choosing a setting based on a sliding scale. This scale signifies to the system just how far the merchant's typical customers are away when they are considering visiting their store. For example, a more rural location may choose a broader radius as driving to another store in the more remote local can signify a propensity to visit, while a store downtown would want to set a tighter radius so only the most relevant customers are considered for the targeting.

In administering the eRewards program, the system enables a member merchant to offer the eReward in exchange for points in the eRewards program. The server computer defines the geo-fence around the place of business of the member merchant. When a client mobile device of a member user is detected within the geo-fence, the server computer may determine whether the member user has sufficient points to redeem the eReward. When the member user has sufficient points to redeem the eReward, the server computer sends a notification to the client mobile device. Preferably, the notification includes an identification of the eReward and a point cost to redeem the eReward. The system sends a purchase link to the client mobile device for the member user to purchase the eReward. The member user has the option to buy the reward or pass on it.

When the member user decides to purchase the eReward, the server sends a confirmation link to the client mobile device including terms and conditions. The server enables the member user to accept the terms and conditions by selecting the confirmation link. When the member user accepts the terms and conditions, the server deducts the points from the member user account in the eRewards program and presents the eReward to the client mobile device for redemption at the member merchant place of business. That is, if the terms and conditions are accepted, the member user will be charged for the amount of points and land on a “thank you” page or the like that can send the user to a “passbook” or other portal or app for this purpose. If the user passes or denies the terms and conditions, the user will be exited out of the application to return to their home screen. The member user can remove themselves from geo-fencing at any point if they don't find value in the product(s).

As noted above, a size of the geo-fence can be varied according to at least one of member user characteristics and member merchant preferences. The geo-fence may be defined differently for different member users according to the member user characteristics. Exemplary member user characteristics include shopping history, location and/or direction and speed of travel. Alternatively or additionally, the size of the geo-fence may be varied according to the type of eReward.

The system and methodology according to preferred embodiments promote higher percentage redemption in an eRewards program. By proactively encouraging users to redeem their points, customer satisfaction is improved.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of administering an eRewards program using dynamic geo-fencing, the method comprising:
(a) enabling a member merchant to offer an eReward in exchange for points in the eRewards program;
(b) a server computer defining a geo-fence around a place of business of the member merchant;
(c) when a client mobile device of a member user is detected within the geo-fence, the server computer determining whether the member user has sufficient points to redeem the eReward; and
(d) when the member user has sufficient points to redeem the eReward, the server computer sending a notification to the client mobile device.

2. A method according to claim 1, wherein the notification sent in step (d) includes an identification of the eReward and a point cost to redeem the eReward, the method further comprising sending a purchase link to the client mobile device for the member user to purchase the eReward.

3. A method according to claim 2, wherein when the member user decides to purchase the eReward, the method further comprising:
the server sending a confirmation link to the client mobile device including terms and conditions;
the server enabling the member user to accept the terms and conditions by selecting the confirmation link; and
when the member user accepts the terms and conditions, the server deducting the points from the member user account in the eRewards program and presenting the eReward to the client mobile device for redemption at the member merchant place of business.

4. A method according to claim 1, wherein step (b) is practiced by varying a size of the geo-fence according to at least one of member user characteristics and member merchant preferences.

5. A method according to claim 4, wherein step (b) is practiced such that the geo-fence is defined differently for different member users according to the member user characteristics.

6. A method according to claim 5, wherein the member user characteristics comprise member shopping history.

7. A method according to claim 5, wherein the member user characteristics comprise member location and direction and speed of travel.

8. A method according to claim 4, wherein the member merchant preferences are determined according to maximum location awareness.

9. A method according to claim 1, wherein step (b) is practiced by varying a size of the geo-fence according to the eReward.

10. A computer system for administering an eRewards program using dynamic geo-fencing, the computer system comprising:
at least one client mobile device of a member user, the client mobile device including a memory, a processor and a display; and
a system server running a server program, the at least one client mobile device and the system server being interconnected by a computer network, the system server including a geo-fence construction resource that establishes a geo-fence around a place of business of a member merchant offering an e-Reward in exchange for points in the eRewards program, wherein the system server is programmed to detect when the at least one client mobile device is physically present within the geo-fence, and wherein when the system server determines that the member user has sufficient points to redeem the eReward, the system server is programmed to send a notification to the client mobile device.

11. A computer system according to claim 10, wherein the system server is programmed to send a confirmation link to the client mobile device including terms and conditions when the member user decides to purchase the eReward, and wherein the system server is programmed to deduct the points from a user account of the member user in the eRewards program, the system server presenting the eReward to the client mobile device for redemption at the member merchant place of business.

12. A computer system method according to claim 10, wherein the geo-fence construction resource varies a size of the geo-fence according to at least one of member user characteristics and member merchant preferences.

13. A computer system according to claim 12, wherein the geo-fence is defined differently for different member users according to the member user characteristics.

14. A computer system according to claim 13, wherein the member user characteristics comprise member shopping history.

15. A computer system according to claim 13, wherein the member user characteristics comprise member location and direction and speed of travel.

16. A computer system according to claim 10, wherein the geo-fence construction resource varies a size of the geo-fence according to the eReward.

17. A method of administering an eRewards program using dynamic geo-fencing, the method comprising:
(a) enabling a member merchant to offer an eReward in exchange for points in the eRewards program;
(b) a server computer defining a geo-fence around a place of business of the member merchant; and
(c) when a client mobile device of a member user is detected within the geo-fence, the server computer sending a notification to the client mobile device,
wherein a size of the geo-fence is selectively variable based on at least one of member merchant preferences, member user characteristics, and the eReward.

18. A method according to claim 17, wherein step (b) is practiced by defining the size of the geo-fence based on both the member merchant preferences and the member user characteristics.

19. A method according to claim 17, further comprising, prior to step (c), the server computer determining whether the member user has sufficient points to redeem the eReward.
